(19) United States
(12) Patent Application Publication
(10) Pub. No.: US 2021/0083552 A1
(43) Pub. Date: Mar. 18, 2021

(54) DUAL INDEPENDENT ACTUATOR ELECTRIC GENERATOR

(71) Applicant: David Deak, Suffern, NY (US)

(72) Inventor: David Deak, Suffern, NY (US)

(21) Appl. No.: 16/933,944

(22) Filed: Jul. 20, 2020

Related U.S. Application Data
(60) Provisional application No. 62/876,615, filed on Jul. 20, 2019.

(51) Int. Cl. H02K 7/18; H02K 1/02

(52) U.S. Cl. CPC H02K 7/1853; H02K 1/02

(57) ABSTRACT

A method of triggering an electromagnetic energy harvesting generator that has disposed two opposite magnets, and each rotatable either clockwise or anti-clockwise within an enclosure about an axis with an axially protruding paddle member each, and movable axially aligned dual offset paddle members, or other flick trigger mechanism structures situated tangent along the surface of the magnets each on opposite sides of a coil that has in its centre, a stationary “centre-field-directive magnet” whose magnetic field poles are centrally common to each opposite bi-directional rotatable opposite magnets. By way of magnetic attractive forces, the two opposite rotatable magnets on opposite sides of the coil are in magnetic equilibrium by the centre stationary magnet disposed within the coil's centre region. Either of the protruding paddle members can be “independently and sequentially pushed” by an external force to cause rotation of either rotatable magnet that is common to each protruding paddle member.

### FIELD OF THE INVENTION

The present invention relates to energy harvesting electrical generators, and single-motion or impulse actuated electrical generators with a damped sinewave output that are superior in instantaneous triggered resultant output compared to instantaneous triggered snap action magnetic circuit types that have a short single electrical pulse output.

### BACKGROUND

Energy harvesting devices cover a wide range of low to high power generation for many applications, especially generating electrical energy from mechanical motion, and have size versus efficiency choices. For those low power applications many are significantly limited; and in general, offer inadequate wide range product utilization. Further efforts by prior art related to continuous or short burst types have not shown significant improvements and do not show any greater problem or application understanding likely to provide any significant improvements thereof.

### SUMMARY

The present invention provides and teaches that a variable speed range of motion triggering can be supplied by an external push force on a plunger embodiment causing the Faraday effect of inducing a voltage to occur at the coil terminals in a continuous or pulsed periodic rotational energy harvesting generator. Whether the plunging movement progression is slow action or fast action once the plunger moves the magnet(s) (responsible for power generation) past the trigger release point of a perpendicular tooth situated on the side of the magnet(s) adjacent to its common axels, the individual response of the power generating magnet(s) situated on opposite sides of a coil in conjunction with a fixed position focusing magnet situated within the centre of the coil creates a “geometrically distorted” and changing magnetic field tensors surrounding and cutting the coil windings, a varying power envelope is produced. The overall Faraday effect of inducing a voltage at the generator coil terminals is further enhanced by utilizing a fixed directive magnet, fixed in the centre of the coil, to concentrate the magnetic field throughout the generator coil windings; and with every movement of a plunger, on a particular side of the coil, in momentary and periodic mechanical connexion to a side situated rotatable magnet, a voltage is produced at the coil terminals due to the Faraday effect of induced voltage through magnetic field changes. With this arrangement a damped sinusoidal alternating voltage, with typical AC wave duration time under a “no-load” condition of several hundred milliseconds, is established at the coil terminals.

The EMF (Electromotive Force, a.k.a. voltage) generated by Faraday's law of induction (the flow of current through a coil around an electrical complete circuit due to relative movement or change of a coil magnetic field) is the phenomenon underlying electrical generators; however, most texts covering the Faraday Principle illustrates a moving coil through a stationary magnetic field source (a magnet), with the present invention the converse holds true where a two independent magnets can be moved rotated on opposite sides of a stationary electric coil and whereby the coil has fixed within its centre, a non-movable magnet. When a permanent magnet is moved relative to a conductor, or the converse condition, an electromotive force (voltage) is created at the coil end terminals. If the coil wire terminals are connected to an electrical load, current will flow in the completed circuit, and thus electrical energy is generated, converting the mechanical energy of motion to electrical energy, thus ‘harvesting’ mechanical energy as electrical energy for some application usage. The embodiment of the present invention has three inline magnets; [1] a centre fixed stationary magnet disposed within the coil winding, [2] an axial bi-directionally rotatable magnet situated the left side of the coil winding, and [3] an axial bi-directionally rotatable magnet situated on the right side of the coil winding; and their combined respective magnetic field polarity is arranged in a completed attractive magnetic force circuit, such that in a rest state with no triggering action, the axial bi-directionally rotatable magnets on opposite sides of the coil winding are in an equilibrium position.

The effect of coil wire gauge in electromagnetic energy harvesting generators, and other types as well, is determined by several mathematical factors. Ergo, consider Ohm's Law for power;

P=V²/Rₗ (induced voltage squared divided by the load resistance) and now relating to Faraday's Law;

V=(N d(B·A)/dt)/Rₗ∝N²/Rₗ∝

Definitions are:

N=No. of turns, Rₗ=load resistance, B=vectoral strength of the magnetic field,

A=coil cross section.

Further consider that the maximum transfer of power is when the coil resistance equals the load resistance. The smaller the coil of wire radius (r), the more turns N can be wound over a length and depth I and p is the specific resistance of the wire gauge.

∴N ∝1/r Then R_{c}=R_{coil}pl∝(1/r²)(πdN)∝(1/r³)

This means that the harvested power should increase proportionally with the radius of the wire.

Power ∝N²/R_{c}∝(1/r)²/(1/r)³∝r

However, the generated voltage decrease with the radius of the wire is;

V_{coil}=N d(B·A)/dt∝1/r This is a crucial mathematical balancing act.

The novelty summarized of this invention is that it is an energy harvesting generator that has one coil with a fixed magnet in the coil centre and at opposite sides of the coil are situated, by a support mechanism, two individual magnets free to rotate about their axis on this support mechanism, and each of the magnets has magnetic poles that are poled diametrically against the rotating axis, and each has one attractive pole that faces the centre fixed magnetic field directive magnet in an attractive magnetic pole situation. Further each bi-directionally rotatable magnet has an offset paddle mechanism that when it is triggered tangentially by an external paddle trigger, the magnet can bi-directionally rotate in either a clockwise or anti-clockwise direction along the axis of rotation. Each rotatable magnet can be rotated independently by two independent tangentially situated paddles and if a rocker (see-saw) component is disposed such that when it is rocked to-and-from, each rotatable magnet can instantly bi-directionally rotate and cause an induced AC ring down voltage in the common coil until axial friction causes the bi-directionally rotatable magnet(s) to stop bi-directionally rotating.

If each bi-directionally rotatable magnet is designated as a left-side bi-directionally rotatable magnet and a right-side bi-directionally rotatable magnet then by Faraday's Law and Lenz' Law, the polarity of the induce voltage will be a sinewave of positive slope rising for one and a negative slope falling for the other.

The present invention's exemplary embodiments include utilizing rare-earth or high field strength magnets such as Neodymium magnets but are not limited using conventional Neodymium magnets. There also exists a novel category of Neodymium magnets that are identified as ‘poly-magnets’. Poly-magnets start as regular rare earth magnets. However, poly-magnets are entirely different from conventional magnets, which have one north and one south pole. Poly-magnets contain patterns of North and South poles, such as alternating north and south pole ‘lines’, on a single piece of magnetic material. The fields coming off of these patterns of north and south poles in turn define the feel and function of the poly-magnet. The field on the poly-magnet is tightly focused because the fields do not have to go as far to connect from north to south. The same amount of energy is present in both magnets, but the poly-magnet has much more energy focused in front of the magnet where it can do work. Note: an every day example of poly-magnets are the flat flexible kitchen magnets, where one side is strongly magnetized, and the other side is weakly magnetized; also called ‘Halbach’ magnets.

### BRIEF DESCRIPTION OF THE DRAWINGS

These and further features of the present invention will be better understood by reading the DETAILED DESCRIPTION, taken together with the DRAWING figures, wherein:

FIG. 1 is an isometric view of the present invention with its base that contains magnets and a coil, and where a top rocker movement style trigger component utilized for dual triggering of independent dual electrical energy generation to offer a source of power to do useful work.

FIG. 2 is an isometric view of the present invention with its base that contains magnets, a coil, and the dual plungers that independently trigger opposite axially rotatable chambers that contain magnets.

FIG. 3 is a side cut-away view of the present invention the coil, dual plungers, dual opposite axially rotatable trigger magnet holders, and the base support that contains all components.

FIG. 4 shows a magnified isometric cut-away view of the generator section of the left plunger and its front trigger paddle that strikes and connect to the left axially rotatable magnet holder and one of its two trigger paddles, which is the front trigger paddle.

FIG. 5 is a cut-away isometric view of the left section of the generator's paddle trigger mechanism showing the left spring supported plunger, the generator base, the rotatable magnet enclosure and its enclosed magnet

FIG. 6 is an isometric exploded view of the complete generator with all components for the present embodiment.

FIG. 7 is a side cut-away view of the present invention showing magnetic field lines on both side of the coil formed by the dual opposite rotatable magnets in combination with the coil stationary centre magnet.

FIG. 8 is a side cut-away view of the present invention showing the left end of the rocker trigger mechanism and the resultant changes of distortion in the left side magnetic field.

FIG. 9 is a side cut-away view of the present invention showing the right end of the rocker trigger mechanism and the resultant changes of distortion in the right side magnetic field.

FIG. 10a is a side cut-away view of the present invention showing a second embodiment using a tapered and curved plastic bendable cantilever springs that are in an uncompressed static-state and part of the under surface of the tangential plunger set 105L and 105R that serves as a spring means instead of a set of four mechanical springs 129lf, 129lr, 129rf, & 129rr in the preferred embodiment.

FIG. 10b is a side cut-away view of the present invention showing a second embodiment using a tapered and curved plastic bendable cantilever springs that are in a compressed active-state and part of the under surface of the tangential plunger set 105L and 105R that serves as a spring means instead of a set of four mechanical springs 129lf, 129lr, 129rf, & 129rr in the preferred embodiment.

FIG. 10c is a bottom view of the second embodiment illustrating the two pairs of tapered and curved plastic bendable cantilever springs that are positioned and disposed on the plunger's undersides.

FIG. 11 is a typical damped sinewave voltage output waveform showing peak-to-peak voltage and the minimum acceptable operational voltage levels (1.8 to 3.3 volts) for micro-transmitter chips currently in the marketplace.

### DETAILED DESCRIPTION OF THE DRAWINGS

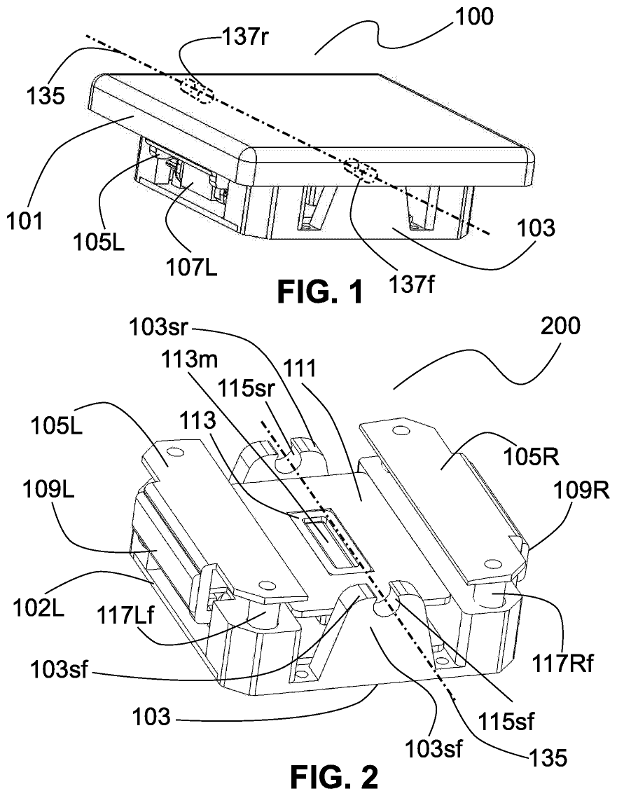

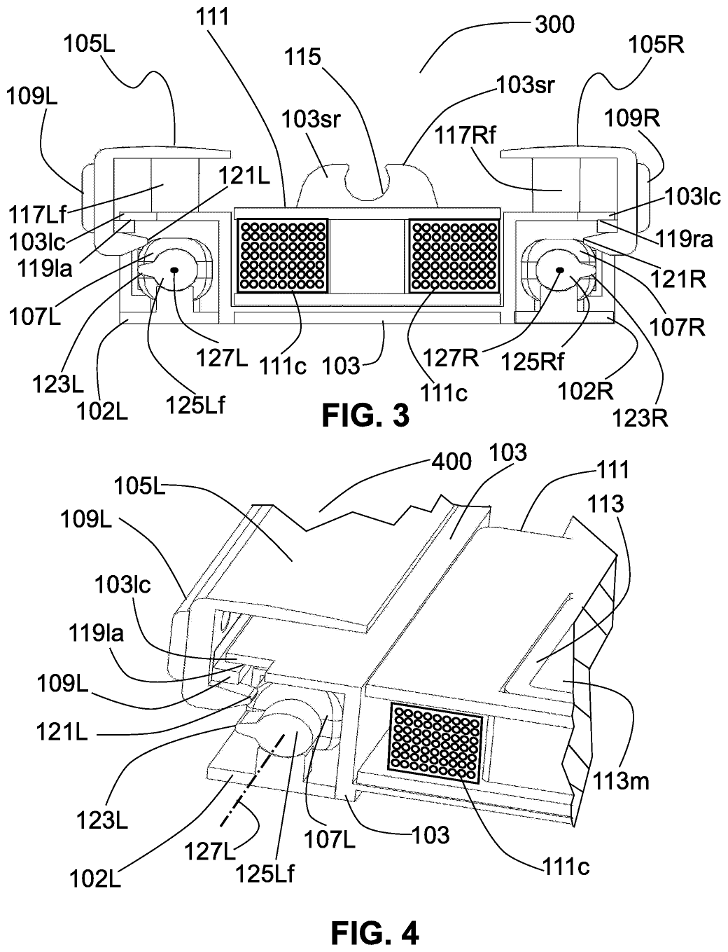

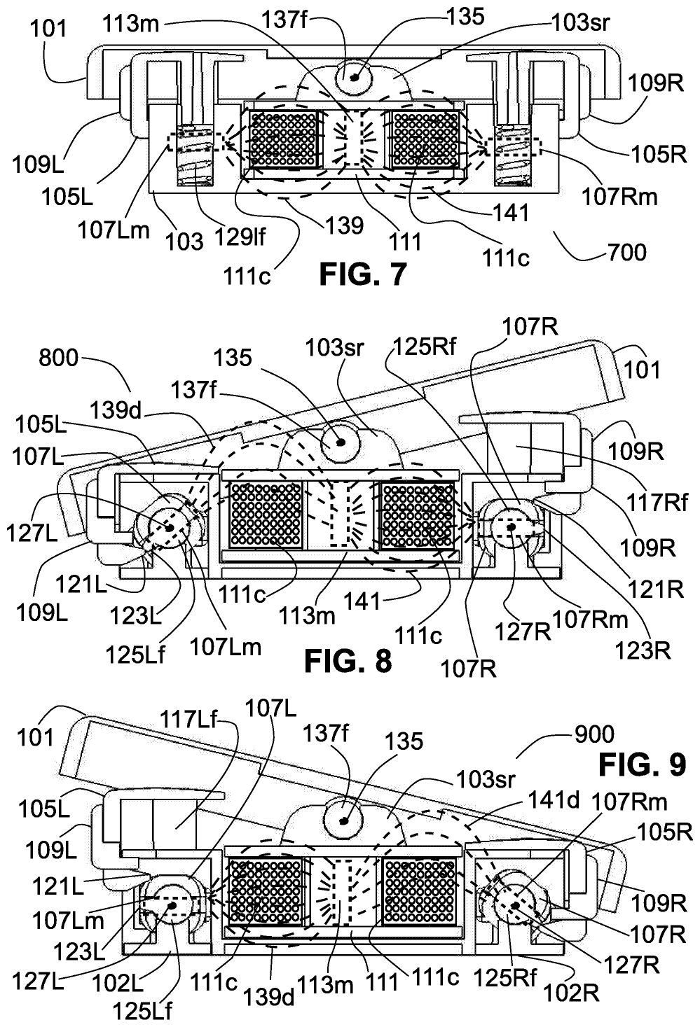

Consider the broad overall pictorial perspective view 100 of the invention in FIG. 1 showing a base bed 103 that contains two rotatable magnet enclosures 107L and 107R (107R not shown; see FIG. 3), which in this view 100 only the left enclosure is shown 107L and this view 100 the only left tangential plunger 105L is shown; this arrangement has a rocker (see-saw) style trigger plate 101 that initiates the triggering of induced electrical energy being generated by movement of the dual opposite rotatable magnets (not shown in this figure; see FIGS. 7, 8, 9) and their respective magnetic fields (no shown in this figure; see FIGS. 7, 8, 9) that are changing during movement in accord with Faraday's Law and this rocker plate 101 is centre positioned along an axis 135 on a dual support section of the base bed 103; and the rocker plate 101 is free to move in a see-saw manner in reference to, and along the centre support axis 135 by dual opposite disposed cylindrical protrusions for each side of the rocker plate 101, there is a front cylindrical protrusion 137f and a rear cylindrical protrusion 137r where both are free to rotate about the base bed 103 vertical front and rear supports 103sf & 103sr (shown in FIG. 2, each with cylindrical snap-in slots 115f & 115r (shown in FIG. 2)) to physically secure the rocker plate 101 to each support slot member (shown in FIG. 2).

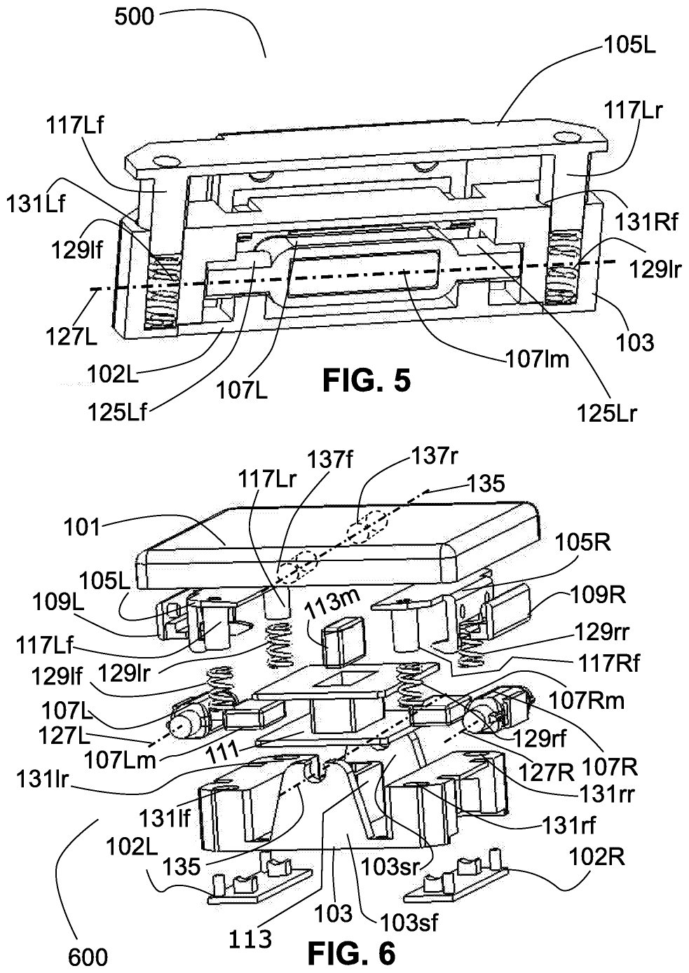

Further, for FIG. 2 this perspective view with the rocker plate 101 removed, shows both the left plunger mechanism 105L and the right plunger mechanism 105R with their respective support cylinder guides left front 117Lf and support cylinder guide right front 117Rf; the rear guides left 117Lr and right 117Rr are not shown in this view but are shown in FIG. 5 and FIG. 6. The plunger action is to move down and up when actuated by the rocker plate 101 movement and the return of the plungers 105L and 105R being displaced downward upon release of the rocker plate 101 by and external operator (human) the plungers will return to an up position rest state forced upward by four compression springs disposed within the base bed 103 four hollow blind holes (not shown) and the four springs exist between the bottom of the base bed holes (not shown) and the four plunger support cylinder guide mechanisms 117Lr and 117Rf, are shown in FIG. 2 (117Lr and 117Rr are shown in FIG. 5 and FIG. 6). Inserted and disposed within the base bed 103 is the coil bobbin with winding 111; this coil 111 is inserted over the base bed 103 that has a centre support 113 with blind hole that contains the centre substantially fixed and stationary magnet 113m. There are two open slots 115f and 115r that disposed on the two base bed 103 vertical rocker supports 103sf and 103sr that contain the snap-in rocker rotatable cylinders 137f and 137r thus enabling the rocker plate 101 to freely move along the axis 135 via the rocker plate's two disposed snap-in rocker rotatable cylinders 137f and 137r.

A cut-away side view in FIG. 3 of the present invention 300 illustrates positioning of the system components all disposed on the base bed 103. There are two independent movable plunger drive mechanisms one on the left side 105L and one on the right side 105R, which both are independently free to move down by the application of an external applied force 105FL & 105RL downward by a finger pressing action applied to the plunger drive mechanism through the rocker plate 101 shown in FIG. 1; the left downward applied force 105FL counteracts the forces of two left side springs (shown in

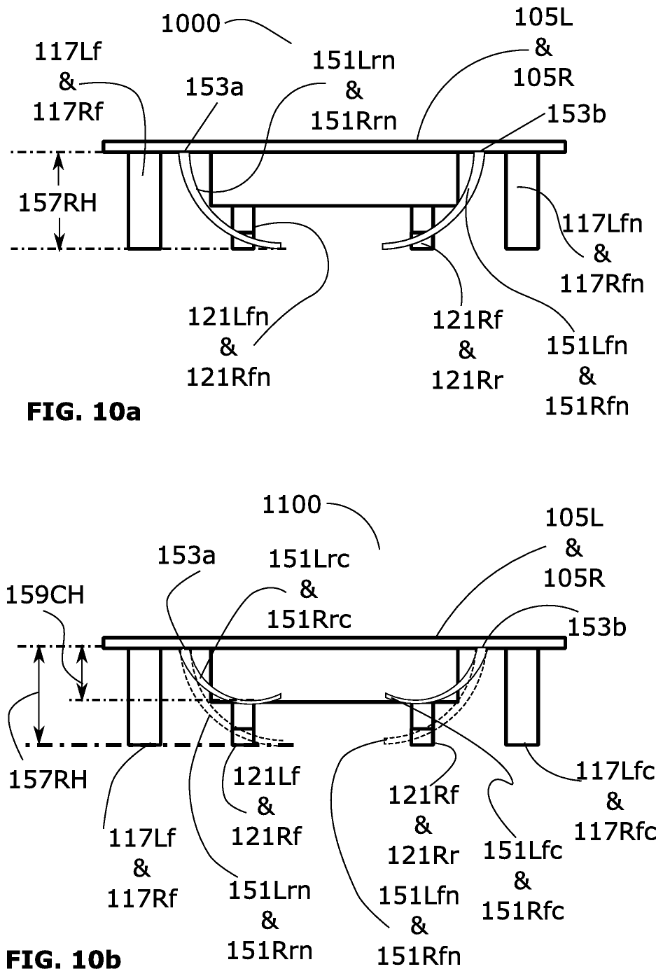

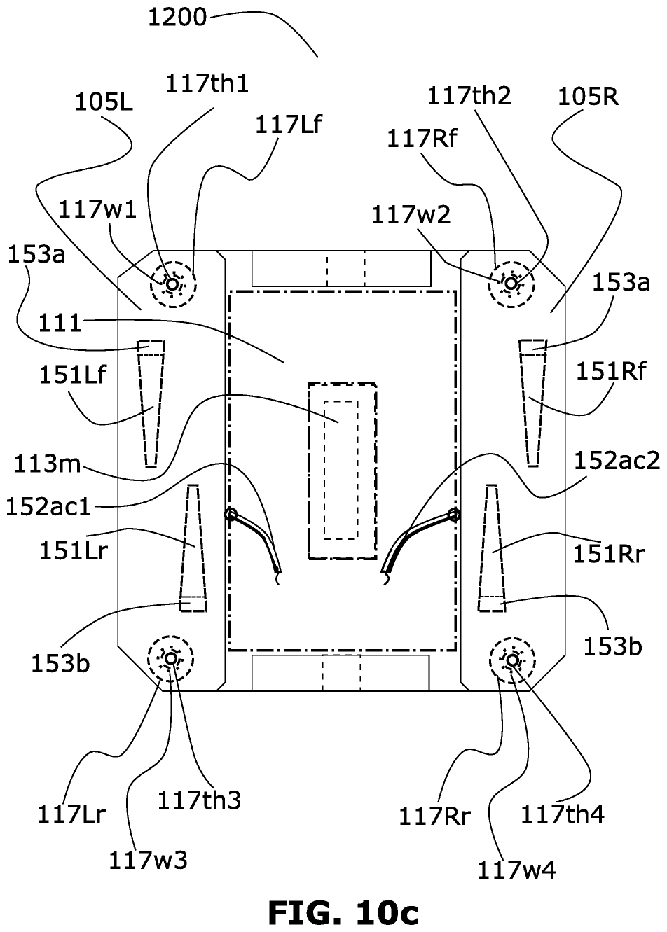

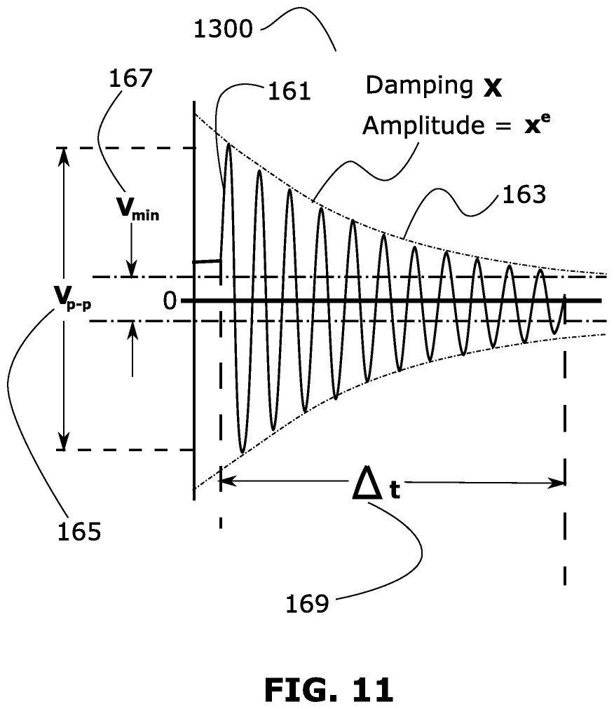

FIG. 10 & FIG. 11; left front spring 129lf and left rear spring 129lr) on each of the two left side plunger guide posts (shown in FIG. 10 & FIG. 11; left front 117Lf & left rear 117Lr). As the downward force on either plunger drive mechanism 105L or 105R is removed, the previously counteracted spring force is removed, the potential energy stored in the springs are now free to be converted into kinetic energy producing an upward force. An additional feature relates to the two plunger stoppers 109L & 109R located on opposite sides and attached to each trigger plunger mechanism 105L & 105R respectively. The plunger stoppers 109L & 109R are inserted onto each trigger plunger mechanism 105L & 105R as a means for butt-up against the under section 119la & 119ra of the chamber sections 103lc & 103rc as part of the base bed 103 embodiment after the push back action occurs by force of the springs 129lf & 129lr (shown in FIG. 11); this action allows for limited travel of the trigger plunger mechanism during the spring-return action.

In FIG. 4, there is a partial cutaway perspective view 400 that shows key elements of the triggering novelty, which are the plunger drive mechanism 105L with its paddle trigger protrusion 121L and the trigger tooth protrusion 123Lf whose action upon a downward force or spring back upward return force causes magnets 107L and its magnetic field 139 that exists between it and the centre fixed magnet 113m, and whilst moving, induces a voltage at the terminals of the coil winding 111c. The field magnets 107L and 107R preferred in this present invention are slab bar magnets that have their magnetic poles at the thin broad sides of the slab configuration for best concentration of the magnetic pole field intensities, but not limited to slab bar magnets.

FIG. 5 is a partial cutaway perspective view 500 of the invention's plunger spring system that has the two opposite plunger shafts 117Lf and 117Lr disposed on the main plunger mechanism 105L and is situated within the blind holes 131Lf & 131Lr as they are in contact with the two opposite springs 129lf & 129lr situated within the blind holes 131Lf & 131Lr. The base bed 103 has an inserted and fixed under-plate support 102 with opposite disposed vertical supports 102Lf & 102Lr for the rotatable magnet enclosure 107L. The role of the under-plate support 102 is to hold in position, in the reference axis 127L, the magnet enclosure 107L and to allow the rotation of the magnet enclosure 107L and magnet 107lm about the reference axis 127L.

FIG. 6 is a perspective view 600 of the invention that first focuses on several previously shown features of the triggering mechanism 105L (especially the left mechanism even though the right mechanism 105R is shown) that shows the two trigger paddle protrusions 121Lf & 121Lr that is disposed on the mechanism 105L and this is when the mechanism 105L is in its rest (non-triggered, non-active, before any applied push force) state and there is no mechanical contact between the trigger paddle teeth protrusions 121Lf & 121Lr that are attached and part of the whole triggering mechanism 105L and the two teeth protrusions 123Lf & 123Lr disposed on the main body of 107L and further disposed exactly on the two separate axles 125Lf & 125Lr in a plane that is parallel to the axis 127Lx. Also shown is the left and right plunger stoppers 109L & 109R that are inserted and fitted onto each respective trigger plunger mechanism 105L & 105R that by their action of butting-up against the two respective under sections 119la & 119ra of the base bed 103 embodiment.

Then second focuses on several previously shown features of the triggering mechanism 105R that shows the two trigger paddle protrusions 121Rf & 121Rr that is disposed on the mechanism 105R and this is when the mechanism 105R is in its rest (non-triggered, non-active, before any applied push force) state and there is no mechanical contact between the trigger paddle teeth protrusions 121Rf & 121Rr that are attached and part of the whole triggering mechanism 105R and the two teeth protrusions 123Rf & 123Rr disposed on the main body of 107R and further disposed exactly on the two separate axles 125Rf & 125Rr in a plane that is parallel to the axis 127Rx. Also shown is the left and right plunger stoppers 109R & 109R that are inserted and fitted onto each respective trigger plunger mechanism 105R & 105L that by their action of butting-up against the two respective under-sections 119ra & 119la of the base bed 103 embodiment. The field magnets 107L and 107R preferred in this present invention are slab bar magnets that have their magnetic poles at the thin broad sides of the slab configuration for best concentration of the magnetic pole field intensities, but not limited to slab bar magnets.

FIG. 7 is a left side cut-away sectional view of the present invention's preferred embodiment in a static state before any human action takes place, for a state change. It shows all three of the magnets in a rest state, where the central stationary magnet 113m remains fixed and stationary in all states (human non-triggered and triggered), and where the left and right bi-directionally rotatable magnets 107Lm & 107Rm at rest; and all three magnets have their magnetic fields aligned in a “trebble attractive, minimum energy state” where the convention would be 107Lm [N-left side of magnet, S-right side of magnet], 113m [N-left side of magnet, S-right side of magnet], and 107Rm [N-left side of magnet, S-right side of magnet] and the rocker paddle 101 is in a temporary fixed state parallel to the horizontal plane. The field magnets 107L and 107R preferred in this present invention are slab bar magnets that have their magnetic poles at the thin broad sides of the slab configuration for best concentration of the magnetic pole field intensities, but not limited to slab bar magnets. The field magnets 107L and 107R preferred in this present invention are slab bar magnets that have their magnetic poles at the thin broad sides of the slab configuration for best concentration of the magnetic pole field intensities, but not limited to slab bar magnets.

FIG. 8 is a left side cut-away sectional view of the present invention's preferred embodiment in an actuated state where the left bi-directionally rotatable magnet 107Lm that is capable of bi-directionally rotating either clockwise or anti-clockwise about its centre axis 127L when triggered by pressing action of the left side of rocker plate 101, and that action instantly forces the triggering mechanism 105L to cause to rotate about its axis 127L, the bi-directionally rotatable magnet that is disposed within its axle-based 127L enclosure 107L in an anti-clockwise direction; and right bi-directionally rotatable magnet 107Rm in this actuation remains in its rest state without movement during this left pressing action. During this action, the attractive North to South magnetic field 139 between the left bi-directionally rotatable magnet 107Lm and the stationary centred magnet 113m changes, where the magnetic lines of force are instantly moved up through the coil winding 111c and by Faraday's law and Special Theory of Relativity (for further causality) makes a change in the moving charges within the coil winding 111c, thus inducing a EMF voltage to be felt at the coil 111c end terminals. Also, during this immediate action, there is no significant change in the magnetic field 141 that exists between the stationary centre magnet 113m and the right side bi-directionally rotatable magnet 107Rm; ergo, the EMF voltage is a result of the bi-directionally rotating action of the left rotatable magnet 107Lm and the magnetic field 139 that will continue to be in a bi-rotational state with less and less displacement and consequently less and less induced voltage until all action stops unless triggered again. The field magnets 107L and 107R preferred in this present invention are slab bar magnets that have their magnetic poles at the thin broad sides of the slab configuration for best concentration of the magnetic pole field intensities, but not limited to slab bar magnets.

FIG. 9 is a left side cut-away sectional view of the present invention's preferred embodiment in an actuated state where the right bi-directionally rotatable magnet 107Rm that is capable of rotating either clockwise or anti-clockwise about its centre axis 127R when triggered by pressing action of the right side of rocker plate 101, and that action instantly forces the triggering mechanism 105R to cause to rotate about its axis 127R, the bi-directionally rotatable magnet that is disposed within its axle-based 127R enclosure 107R in an anti-clockwise direction; and left bi-directionally rotatable magnet 107Lm in this actuation remains in its rest state without movement during this left pressing action. During this action, the attractive North to South magnetic field 141 between the right bi-directionally rotatable magnet 107Rm and the stationary centred magnet 113m changes, where the magnetic lines of force are instantly moved up through the coil winding 111c and by Faraday's law and Special Theory of Relativity (for further causality) makes a change in the moving charges within the coil winding 111c, thus inducing a EMF (Electromotive Force) voltage to be felt at the coil 111c end terminals. Also, during this immediate action, there is no significant change in the magnetic field 139 that exists between the stationary centre magnet 113m and the left side bi-directionally rotatable magnet 107Lm; ergo, the EMF (Electromotive Force) voltage is a result of the bi-directionally rotating action of the right bi-directionally rotatable magnet 107Rm and the magnetic field 141 that will continue to be in a bi-directionally rotational state with less and less displacement and consequently less and less induced voltage until all action stops unless triggered again. The field magnets 107L and 107R preferred in this present invention are slab bar magnets that have their magnetic poles at the thin broad sides of the slab configuration for best concentration of the magnetic pole field intensities, but not limited to slab bar magnets.

FIG. 10a is an alternative second embodiment 1000 with features utilized as an alternative to the use of four mechanical springs (shown in FIGS. 6 as 129lf, 129lr, 129rf, & 129rr) in the preferred embodiment of all the previous preferred embodiment figures in this document; whereby disposed at attach points 153a & 153b two pairs (one pair each for each left and right plunger mechanism 105L &105R) of opposing bendable cantilever plastic springs with the first disposed at attach points 153a & 153b pair 151Lfn & 151Lrn for the left plunger 105L; and the second disposed at attach points 153a & 153b pair 151Rfn & 151Rrn, and both pairs comprised of Nylon with 30% glass or similar bendable plastic with low coefficient of friction, which is used for purposes of bending and compressing to a minimum position height 159CH (shown in FIG. 10b) below the value of uncompressed rest height 157RH (shown in FIG. 10a) relative to the downward and upward operational triggering action during observer interaction.

FIG. 10b shows the alternative second embodiment 1100 in illustration of the bendable curvilinear plastic springs, whereby whenever either of the plungers 105L or 105R are depressed downward by an observer (operator), the overall height of the plastic bendable cantilever springs 151Lfn, 151Rfn and 151Lrn, 151Rfn changes from the rest height 157RH (maximum) to compressed height 159CH (minimum).

FIG. 10c is a bottom view illustration of the alternative second embodiment 1200 that has an altered-inline pair 151Lf & 151Lr disposed on the left plunger 105L; and has a second altered-inline pair 151Rf & 151Rr disposed on the right plunger 105R. The four bendable curvilinear plastic springs 151Lf, 151Lr, and 151Rf, 151Rr are all part of the completed moulded plunger parts 105L and 105R respectfully; however, not limited to the four bendable curvilinear plastic springs 151Lf, 151Lr, and 151Rf, 151Rr having to be part of the single component of the plunger parts 105L & 105R and the bendable curvilinear plastic springs bendable curvilinear plastic springs 151Lf, 151Lr, and 151Rf, 151Rr can be fabricated as separate moulded parts and physically attached, by an ultrasonic welding process or similar permanent bonding method, to the plungers 105L & 105R. The coil bobbin 111 and fixed stationary centre magnet 113m are shown for position reference. Also shown in FIG. 10c are dotted hidden views of the four plunger shafts 117Lf, 117Lr, 117Rf, 117Rr and their respective air escape through holes 117th1, 117th2, 117th3, 117th4 and the air escape through holes serve to minimize any built up pressure in the respective shaft wells 117w1, 117w2, 117w3, 117w4 (where 117w1 & 117w2 are shown in FIGS. 7 and 117w3 & 117w4 are not in view) during the action or pressing the rocker style trigger plate 101 as shown in FIG. 1. The field magnets 107L and 107R preferred in this present invention are slab bar magnets that have their magnetic poles at the thin broad sides of the slab configuration for best concentration of the magnetic pole field intensities, but not limited to slab bar magnets.

In FIG. 11, the graphical analysis 1300 of the damped sinusoidal output waveform 161 produced by the present invention's preferred embodiment 100 of FIG. 1 that has the damping amplitude 163, due to friction and the coil's self inductance, to followed in time by the descending curvilinear function x^{e}. Ergo, when the rocker plunger plate 101 is pressed in either direction (left or right side pushing force) the damped sinusoidal output waveform 161 is generated starting with an initial peak-to-peak voltage level of maximum Vₚ₋ₚ 165 and descending over the delta time period Δt 169 to a minimum Vₘᵢₙ usable value 167. For most current micro-transmitter modules the minimum usable value range is 1.8 to 3.3 volts DC. Being that the present embodiment is an AC generator other means of rectification from AC to DC voltage would be left to the user to design as a completed DC regulated voltage supply.

What is claimed is:

1. An electrical generator, comprising:
a method means, a device means, and a structural means of triggering an electromagnetic energy harvesting generator including;
a plurality of turns of wire coil winding disposed substantially around an outside wall of a coil bobbin having a centre through hole and having a circumference and having a parallel axis of symmetry therethough,
a first substantially shaped rectangular slab Neodymium bar magnet that s magnetised through its width;
and is substantially disposed at a first distal in a transverse plane from a centre disposed and substantially fixed stationary second substantially shaped rectangular slab Neodymium bar magnet that is magnetised through its thickness;
and where said first substantially shaped rectangular slab Neodymium bar magnet is retained in a first rotatable volume member having a centre axle extending therefrom and rotatable about said axis of symmetry therethrough, and a surface distal from said axle;
and a third substantially shaped rectangular slab Neodymium bar magnet that is magnetised through its width;
and is substantially disposed at a second and opposite distal from first distal in a transverse plane from said centre disposed and substantially fixed stationary second substantially shaped rectangular slab Neodymium bar magnet;
and where said third substantially shaped rectangular slab Neodymium bar magnet is retained in a second rotatable volume member having a centre axle extending therefrom and rotatable about said axis of symmetry therethough, and a surface distal from said axle;
and where said centre disposed and substantially fixed stationary second substantially shaped rectangular slab Neodymium bar magnet that is magnetised through its thickness is retained in a third substrate volume member having a substantially shaped protrusion means where said coil bobbin is disposed through said third volume substrate member and retained;
and where said centre disposed and substantially fixed stationary second substantially shaped rectangular slab Neodymium bar magnet, magnetise through its thickness is a means for substantially guiding the magnetic fields of said first rotatable magnet and said third rotatable magnet throughout said coil winding sides opposite said coil bobbin sides facing of said first and third magnets that are magnetised each through their respective widths;
a horizontal base substrate surface member having a vertically disposed, said centred third substrate volume member that retains said second centred magnet, magnetised through its thickness;
and a vertically disposed, fourth substrate volume member that retains said first magnet retained in its said first rotatable volume member disposed on one side proximal-distal of said centred third substrate volume member that retains said second centred magnet, magnetised through its thickness;
and where said vertically disposed fourth substrate volume member has a first draft angled inline through hole at one end and a second distal draft angled inline through hole at opposite end;
and a vertically disposed, fifth substrate volume member that retains said third magnet in its second rotatable volume member disposed on side opposite and proximal-distal from third volume member with retained coil bobbin winding;
and where said vertically disposed fifth substrate volume member has a first draft angled inline through hole at one end and a second distal draft angled inline through hole at opposite end;
a trigger flange encompassed snap fitted rocker paddle member with two contiguous center snap fitted axle segment members disposed at opposite ends under said rocker paddle bottom and hidden by said encompassed flange;
a vertically disposed on said base substrate opposite end pair of front and rear trigger rocker paddle axle supports, each with a top disposed sectored through hole with said sector area open at said top for retaining said snap fitted trigger rocker paddle support axle segment members;
and said snap fitted axle segment members are disposed and retained within said trigger rocker paddle axle support members;
a first horizontal plunger drive platform member with a first disposed draft angled inline hollow cylinder with a first disposed blind hole, and said first draft angled inline hollow cylinder is disposed at one end of said first horizontal plunger drive platform member, and at opposite end of said first horizontal plunger drive platform member there exists an inline distal second disposed draft angled hollow cylinder with a second disposed blind hole;
and where a slidably fitted first compression spring is disposed within said first disposed draft angled hollow cylinder with said disposed first blind hole, and where said slidably fitted first compression spring is longer than the depth of said first blind hole;
and where a slidably fitted second compression spring is disposed within said second disposed draft angled inline hollow cylinder with a disposed second blind hole, and where said slidably fitted second compression spring is longer than the depth of said second blind hole;
a second horizontal plunger drive platform member with a first disposed draft angled inline hollow cylinder with a first disposed blind hole, and said first disposed draft angled inline hollow cylinder is disposed at one end of said second horizontal plunger drive platform member, and at opposite end of said second horizontal plunger drive platform member there exists an inline distal second disposed draft angled hollow cylinder with a second disposed blind hole;
and where in said second horizontal plunger drive platform member, a first slidably fitted compression spring is disposed within said first disposed draft angled hollow cylinder with said disposed first blind hole, and where said slidably fitted first compression spring is longer than the depth of said first blind hole;
and where in said second horizontal plunger drive platform member a second slidably fitted compression spring is disposed within said second disposed draft angled inline hollow cylinder with a disposed second blind hole, and where said second slidably fitted compression spring is longer than the depth of said second blind hole;
and an ensemble of said first horizontal plunger drive platform member and including its said first and said second disposed inline slidably fitted compression springs disposed within said first and said second through holes of said third substrate volume member and are disposed and slidably fitted and free to move up and down in relation to said fixed third substrate volume member upon a push force applied thereto;
and an ensemble of said second horizontal plunger drive platform member and including its said first and said second disposed inline slidably fitted compression springs disposed within its said first and said second through holes of said fourth substrate volume member and are slidably fitted and free to move up and down in relation to said fixed fourth substrate volume member upon a push force applied thereto;
and disposed on one side of said first horizontal plunger drive platform is a first inline right angled vertical extension member substantially disposed with a first trigger tooth end tapered member extension, substantially protruding in said horizontal plane and said first inline right angled vertical extension member is substantially disposed with a trigger tooth end tapered member extension substantially protruding in said horizontal plane, and disposed on opposite side of said first horizontal plunger drive platform is a second inline right angled vertical extension member substantially disposed with a second trigger tooth end tapered member extension substantially protruding in said horizontal plane;
and the ensemble of said first horizontal plunger drive platform is a device for triggered movement of said first substantially shaped rectangular slab Neodymium bar magnet that is retained in a first rotatable volume member having a centre axle extending therefrom and rotatable about said axis of symmetry therethrough, and said ensemble strikes said first rotatable volume member containing said first substantially shaped rectangular slab Neodymium bar magnet that is disposed with a substantially strikable horizontal paddle member disposed on said first rotatable volume member with centre axle extending therefrom and rotatable about said axis of symmetry therethrough;
and disposed on one side of said second horizontal plunger drive platform is a first inline right angled vertical extension member substantially disposed with a first trigger tooth end tapered member extension substantially protruding in said horizontal plane and said first inline right angled vertical extension member substantially disposed with a trigger tooth end tapered member extension substantially protruding in said horizontal plane, and disposed on opposite side of said second horizontal plunger drive platform is a second inline right angled vertical extension member substantially disposed with a first trigger tooth end tapered member extension substantially protruding in said horizontal plane and said first inline right angled vertical extension member substantially disposed with a trigger tooth end tapered member extension substantially protruding in said horizontal plane;
and the ensemble of said second horizontal plunger drive platform is a device for triggered movement of said second substantially shaped rectangular slab Neodymium bar magnet that is retained in a second rotatable volume member having a centre axle extending therefrom and rotatable about said axis of symmetry therethrough, and said ensemble strikes said second rotatable volume member containing said second substantially shaped rectangular slab Neodymium bar magnet that is disposed with a substantially strikable horizontal paddle member disposed on said second rotatable volume member with centre axle extending therefrom and rotatable about said axis of symmetry therethrough;
a first vertical travel limit stopper disposed and retained on said first horizontal plunger drive platform ensemble, and is a device for limiting the downward travel of said first horizontal plunger drive platform ensemble by contiguous method means;
a second vertical travel limit stopper disposed and retained on said second horizontal plunger drive platform ensemble, and is a device for limiting the downward travel of said second horizontal plunger drive platform ensemble by contiguous method means;
a first axle support member that is disposed and retained bottom under said vertically disposed fourth substrate volume member that is disposed on said horizontal base substrate surface member, where said first axle support member is a device for under-axle support for said first substantially shaped rectangular slab Neodymium bar magnet that is disposed with a substantially strikable horizontal paddle member disposed on said second rotatable volume member with centre axle extending therefrom and rotatable about said axis of symmetry therethrough;
a second axle support member that is disposed and retained bottom under said vertically disposed fifth substrate volume member that is disposed on said horizontal base substrate surface member, where said second axle support member is a device for under-axle support for said second substantially shaped rectangular slab Neodymium bar magnet that is disposed with a substantially strikable horizontal paddle member disposed on said second rotatable volume member with centre axle extending therefrom and rotatable about said axis of symmetry therethrough;
and where said trigger flange encompassed snap fitted rocker paddle member with two contiguous center snap fitted axle segment members disposed at opposite ends under said rocker paddle bottom and hidden by said encompassed flange in a quiescent state with no triggering, has its paddle member surface substantially quiescent parallel to said horizontal plane;
and where an external downward force exerts a contiguous urging on said snap fitted rocker paddle member area nearest to said first substantially shaped rectangular slab Neodymium bar magnet that is disposed with a substantially strikable horizontal paddle member disposed on said first rotatable volume member, said first rotatable volume member rotates anti-clockwise by means of said first horizontal plunger drive platform member ensemble and is released from said first plunger platform protruding tooth that strikes and passes beyond said paddle member width and releases first rotatable volume member containing its first Neodymium magnet this first causal action provides damped oscillatory rotation of said first Neodymium magnet retained in said first rotatable volume member and thereby induces an AC voltage at said coil winding terminals for a substantial time duration;
and where an external downward force exerts a contiguous urging on said snap fitted rocker paddle member area nearest to said second substantially shaped rectangular slab Neodymium bar magnet that is disposed with a substantially strikable horizontal paddle member disposed on said second rotatable volume member, said second rotatable volume member rotates clockwise, relative to said first substantially shaped rectangular slab Neodymium bar magnet that is disposed with a substantially strikable horizontal paddle member disposed on said second rotatable volume member, by means of said second horizontal plunger drive platform member ensemble and is released from said second plunger platform protruding tooth that strikes and releases second rotatable volume member containing its second Neodymium magnet and this second causal action provides damped oscillatory rotation of said second Neodymium magnet retained in said second rotatable volume member and thereby induces an AC voltage at said coil winding terminals for a substantial time duration;
